(19) United States
(12) Patent Application Publication
(10) Pub. No.: US 2023/0377017 A1
(43) Pub. Date: Nov. 23, 2023

(54) DATA RETRIEVAL AND DELIVERY USING ATTRIBUTE MAPPING

(71) Applicant: Narrative I/O, Inc., New York, NY (US)

(72) Inventors: Nicholas Jordan, Brooklyn, NY (US); Marko Babic, Victoria (CA)

(21) Appl. No.: 18/143,018

(22) Filed: May 3, 2023

Related U.S. Application Data
(60) Provisional application No. 63/343,455, filed on May 18, 2022.

(51) Int. Cl. G06Q 30/0601

(52) U.S. Cl. CPC G06Q 30/0625

(57) ABSTRACT

A computer-implemented method may be used to manage access to data over a network. The method may include automatically reading a first dataset to infer one or more data types of data within the first dataset and making a data product available over the network. The data product may include at least part of the first dataset. The method may further include receiving a first search query from a user specifying one or more attributes of data desired by the user. The attributes may be based on the data types. The method may further include, responsive to the first search query, identifying a first subset of the first dataset that possesses the attributes. Yet further, the method may include displaying results of the first search query for the user.

### RELATED APPLICATIONS

This application claims the benefit of U.S. Provisional Patent Application Ser. No. 63/343,455 filed on May 18, 2022 and entitled “Data Retrieval and Delivery Using Attribute Mapping.” The foregoing is incorporated by reference as though set forth herein in its entirety.

### TECHNICAL FIELD

The present document relates to improved mechanisms and features for data retrieval.

### BACKGROUND

Data retrieval can be challenging when a large number of data sources exist, each containing data in different formats and arrangements. In particular, buyers of data can find it extremely difficult to find comprehensive, relevant data when working with multiple large-scale data sources and/or datasets, each having its own set of attributes and each representing its data in a potentially different way. Existing data preparation and transaction systems often lack the ability to facilitate the sale of differently formatted datasets, which may be from different sources.

### SUMMARY

Described herein are various techniques for automatic and real-time translation of any number of data providers' data, encoded in any arbitrary way, into a set of standardized attributes that allows for easy, simple and efficient retrieval and/or consumption of the data at massive scale. A coherent and unified interface is provided for searching for and retrieving such data. Using the techniques described herein, data consumers (buyers) can specify their data needs and execute searches while remaining agnostic as to the source of the data.

Various embodiments described herein provide mechanisms for seamlessly and transparently organizing data across any number of datasets containing any number of arbitrary data types, to generate a unified, searchable dataset having unified, consistent attributes. In this manner, the described system allows a buyer to specify their data needs without needing to specify a particular data source. In addition, the buyer need not worry about data cleansing and/or normalization across disparate datasets.

Further details are provided below.

### BRIEF DESCRIPTION OF THE DRAWINGS

The accompanying drawings, together with the description, illustrate several embodiments. One skilled in the art will recognize that the particular embodiments illustrated in the drawings are merely exemplary, and are not intended to limit scope.

FIG. 1 is a block diagram depicting a hardware architecture for implementing the techniques described herein according to one embodiment.

FIG. 2 is a block diagram depicting a hardware architecture for implementing the techniques described herein in a client/server environment, according to one embodiment.

FIG. 3 a schematic diagram showing an example of an overall system architecture, according to one embodiment.

FIG. 4 is a screenshot showing user launch of a software application for purchasing data, according to one embodiment.

FIG. 5 is a screenshot showing user creation of a new data subscription, according to one embodiment.

FIG. 6 is a screenshot showing user specification of data attributes for the new data subscription of FIG. 5, according to one embodiment.

FIGS. 7A, 7B, 7C, and 7D are screenshots showing user specification of filters for the new data subscription of FIG. 5, according to one embodiment.

FIG. 8 is a screenshot showing user specification of which sellers to purchase from for the new data subscription of FIG. 5, according to one embodiment.

FIG. 9 is a screenshot showing user specification of where the purchased data should be delivered for the new data subscription of FIG. 5, according to one embodiment.

FIG. 10 is a screenshot showing user specification of a budget and frequency of data delivery for the new data subscription of FIG. 5, according to one embodiment.

FIG. 11 is a screenshot showing user specification of a payment method for the new data subscription of FIG. 5, according to one embodiment.

FIG. 12 is a screenshot showing user confirmation of purchase of the new data subscription of FIG. 5, according to one embodiment.

FIG. 13 is a table of data from three different providers, according to one embodiment.

FIG. 14 is a screenshot showing a user interface for specifying the desired data, according to one embodiment.

FIG. 15 is a table of data showing the output generated pursuant to the user selections of FIG. 14, according to one embodiment.

FIG. 16 is a flow diagram of a method by which a query compiler services a user's query, according to one embodiment.

FIG. 17 is a screenshot showing use of forecasting to determine the approximate number of rows that match their query, according to one embodiment.

FIG. 18 is a schematic flow diagram showing how forecasting may be carried out, according to one embodiment.

FIG. 19 is a schematic flow diagram showing how joining may be carried out, according to one embodiment.

FIG. 20 is a schematic diagram depicting a method for schema inference according to one embodiment.

### DETAILED DESCRIPTION OF THE EMBODIMENTS

The techniques described herein provide a system for implementing a flexible queryable, standardized ontology that can be applied to any data at any scale. The system unifies and catalogs data so as to facilitate delivery of diverse datasets to buyers in response to queries. A query compiler is provided to leverage datasets, attributes, and mappings to efficiently execute queries.

In at least one embodiment, the techniques described here are used by a data buyer (user) when they are selecting attributes of interest that they wish to receive when purchasing data. One skilled in the art will recognize that the described techniques can also be used in other contexts.

### Definitions

For purposes of the following description:
A user, buyer, or data buyer is any individual or other entity who is seeking to purchase or acquire data.
A provider is an individual or entity who is seeking to make their data available to others.
An administrator or system administrator is an individual or entity who is responsible for operating and maintaining the system.
A dataset is a body of structured information representing data that a provider has made available. In at least one embodiment, a dataset may include:
   A name and/or identifier for the dataset;
   A schema including a description of properties included in the data set and their types (for example, a dataset containing geographical location data might contain properties such as “latitude” and “longitude”, each having the type “number”).
A field is part of a dataset that encompasses data of a similar type, often (but not necessarily) including comparable elements of different records.
An attribute is an aspect of data that may include a data type, a specific field, and/or the like.
A data type is a classification of data by format, purpose, and/or the like; for example, “alphanumeric,” “integer,” “temperature,” “location,” and “country” are all data types. A data type may apply to all data in a field.
A subset of a dataset is part, but not all, of the dataset.

### System Architecture

According to various embodiments, the systems and methods described herein can be implemented on any electronic device or set of interconnected electronic devices, each equipped to receive, store, and present information. Each electronic device may be, for example, a server, desktop computer, laptop computer, smartphone, tablet computer, and/or the like. As described herein, some devices used in connection with the systems and methods described herein are designated as client devices, which are generally operated by end users. Other devices are designated as servers, which generally conduct back-end operations and communicate with client devices (and/or with other servers) via a communications network such as the Internet. In at least one embodiment, the techniques described herein can be implemented in a cloud computing environment using techniques that are known to those of skill in the art.

In addition, one skilled in the art will recognize that the techniques described herein can be implemented in other contexts, and indeed in any suitable device, set of devices, or system capable of interfacing with existing enterprise data storage systems. Accordingly, the following description is intended to illustrate various embodiments by way of example, rather than to limit scope.

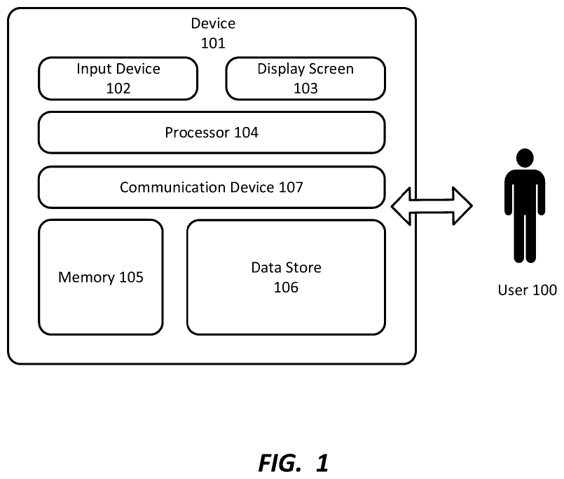

Referring now to FIG. 1, there is shown a block diagram depicting a hardware architecture for practicing the described system, according to one embodiment. Such an architecture can be used, for example, for implementing the techniques of the system in a computer or other device 101. Device 101 may be any electronic device.

In at least one embodiment, device 101 includes a number of hardware components that are well known to those skilled in the art. Input device 102 can be any element that receives input from user 100, including, for example, a keyboard, mouse, stylus, touch-sensitive screen (touchscreen), touchpad, trackball, accelerometer, microphone, or the like. Input can be provided via any suitable mode, including for example, one or more of: pointing, tapping, typing, dragging, and/or speech. In at least one embodiment, input device 102 can be omitted or functionally combined with one or more other components.

Data store 106 can be any magnetic, optical, or electronic storage device for data in digital form; examples include flash memory, magnetic hard drive, CD-ROM, DVD-ROM, or the like. In at least one embodiment, data store 106 stores information that can be utilized and/or displayed according to the techniques described below. Data store 106 may be implemented in a database or using any other suitable arrangement. In another embodiment, data store 106 can be stored elsewhere, and data from data store 106 can be retrieved by device 101 when needed for processing and/or presentation to user 100. Data store 106 may store one or more data sets, which may be used for a variety of purposes and may include a wide variety of files, metadata, and/or other data.

In at least one embodiment, data store 106 may store datasets, attributes, mappings, seller profiles, buyer profiles, and/or the like. In at least one embodiment, such data can be stored at another location, remote from device 101, and device 101 can access such data over a network, via any suitable communications protocol.

In at least one embodiment, data store 106 may be organized in a file system, using well known storage architectures and data structures, such as relational databases. Examples include Oracle, MySQL, and PostgreSQL. Appropriate indexing can be provided to associate data elements in data store 106 with each other. In at least one embodiment, data store 106 may be implemented using cloud-based storage architectures such as NetApp (available from NetApp, Inc. of Sunnyvale, California) and/or Amazon Simple Storage Service (Amazon S3) (available from Amazon.com of Seattle, Washington).

Data store 106 can be local or remote with respect to the other components of device 101. In at least one embodiment, device 101 is configured to retrieve data from a remote data storage device when needed. Such communication between device 101 and other components can take place wirelessly, by Ethernet connection, via a computing network such as the Internet, via a cellular network, or by any other appropriate communication systems.

In at least one embodiment, data store 106 is detachable in the form of a CD-ROM, DVD, flash drive, USB hard drive, or the like. Information can be entered from a source outside of device 101 into a data store 106 that is detachable, and later displayed after the data store 106 is connected to device 101. In another embodiment, data store 106 is fixed within device 101.

In at least one embodiment, data store 106 may be organized into one or more well-ordered data sets, with one or more data entries in each set. Data store 106, however, can have any suitable structure. Accordingly, the particular organization of data store 106 need not resemble the form in which information from data store 106 is displayed to user 100 on display screen 103. In at least one embodiment, an identifying label is also stored along with each data entry, to be displayed along with each data entry.

Display screen 103 can be any element that displays information such as text and/or graphical elements. In particular, display screen 103 may present a user interface for entering, viewing, configuring, selecting, editing, downloading, and/or otherwise interacting with datasets as described herein. In at least one embodiment where only some of the desired output is presented at a time, a dynamic control, such as a scrolling mechanism, may be available via input device 102 to change which information is currently displayed, and/or to alter the manner in which the information is displayed.

Processor 104 can be a conventional microprocessor for performing operations on data under the direction of software, according to well-known techniques. Memory 105 can be random-access memory, having a structure and architecture as are known in the art, for use by processor 104 in the course of running software.

Communication device 107 may communicate with other computing devices through the use of any known wired and/or wireless protocol(s). For example, communication device 107 may be a network interface card (“NIC”) capable of Ethernet communications and/or a wireless networking card capable of communicating wirelessly over any of the 802.11 standards. Communication device 107 may be capable of transmitting and/or receiving signals to transfer data and/or initiate various processes within and/or outside device 101.

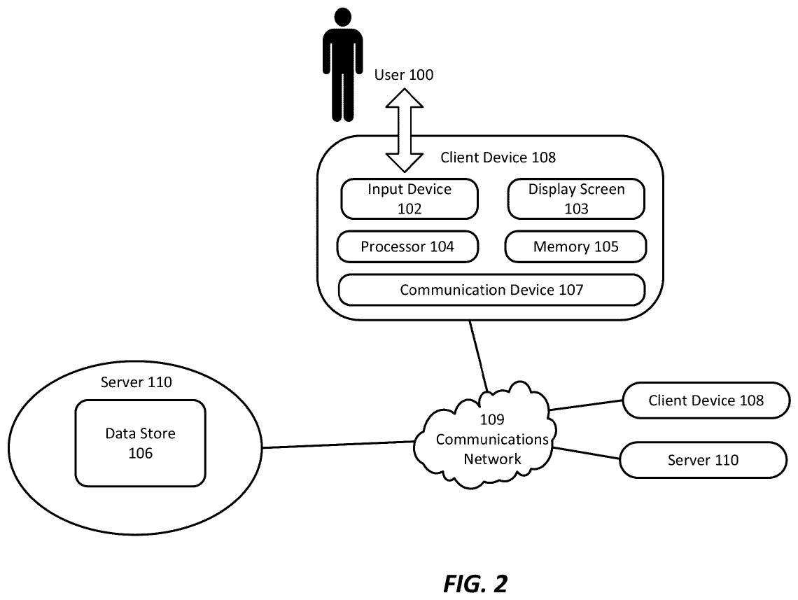

Referring now to FIG. 2, there is shown a block diagram depicting a hardware architecture in a client/server environment, according to one embodiment. Such an implementation may use a “black box” approach, whereby data storage and processing are done completely independently from user input/output. An example of such a client/server environment is a web-based implementation, wherein client device 108 runs a browser that provides a user interface for interacting with web pages and/or other web-based resources from server 110. Items from data store 106 can be presented as part of such web pages and/or other web-based resources, using known protocols and languages such as Hypertext Markup Language (HTML), Java, JavaScript, and the like.

Client device 108 can be any electronic device incorporating the input device 102 and/or display screen 103, such as a desktop computer, laptop computer, personal digital assistant (PDA), cellular telephone, smartphone, music player, handheld computer, tablet computer, kiosk, game system, wearable device, or the like. Any suitable type of communications network 109, such as the Internet, can be used as the mechanism for transmitting data between client device 108 and server 110, according to any suitable protocols and techniques. In addition to the Internet, other examples include cellular telephone networks, EDGE, 3G, 4G, 5G, long term evolution (LTE), Session Initiation Protocol (SIP), Short Message Peer-to-Peer protocol (SMPP), SS7, Wi-Fi, Bluetooth, ZigBee, Hypertext Transfer Protocol (HTTP), Secure Hypertext Transfer Protocol (SHTTP), Transmission Control Protocol/Internet Protocol (TCP/IP), and/or the like, and/or any combination thereof. In at least one embodiment, client device 108 transmits requests for data via communications network 109, and receives responses from server 110 containing the requested data. Such requests may be sent via HTTP as remote procedure calls or the like.

In one implementation, server 110 is responsible for data storage and processing, and incorporates data store 106. Server 110 may include additional components as needed for retrieving data from data store 106 in response to requests from client device 108.

As described above in connection with FIG. 1, data store 106 may be organized into one or more well-ordered data sets, with one or more data entries in each set. Data store 106, however, can have any suitable structure, and may store data according to any organization system known in the information storage arts, such as databases and other suitable data storage structures. As in FIG. 1, data store 106 may store datasets, attributes, mappings, seller profiles, buyer profiles, and/or the like; alternatively, such data can be stored elsewhere (such as at another server) and retrieved as needed.

In addition to or in the alternative to the foregoing, data may also be stored in a data store 106 that is part of client device 108. In some embodiments, such data may include elements distributed between server 110 and client device 108 and/or other computing devices in order to facilitate secure and/or effective communication between these computing devices.

As discussed above in connection with FIG. 1, display screen 103 can be any element that displays information such as text and/or graphical elements. Various user interface elements, dynamic controls, and/or the like may be used in connection with display screen 103.

As discussed above in connection with FIG. 1, processor 104 can be a conventional microprocessor for use in an electronic device to perform operations on data under the direction of software, according to well-known techniques. Memory 105 can be random-access memory, having a structure and architecture as are known in the art, for use by processor 104 in the course of running software. A communication device 107 may communicate with other computing devices through the use of any known wired and/or wireless protocol(s), as discussed above in connection with FIG. 1.

In one embodiment, some or all of the system can be implemented as software written in any suitable computer programming language, whether in a standalone or client/server architecture. Alternatively, some or all of the system may be implemented and/or embedded in hardware.

Notably, multiple client devices 108 and/or multiple servers 110 may be networked together, and each may have a structure similar to those of client device 108 and server 110 that are illustrated in FIG. 2. The data structures and/or computing instructions used in the performance of methods described herein may be distributed among any number of client devices 108 and/or servers 110. As used herein, “system” may refer to any of the components, or any collection of components, from FIGS. 1 and/or 2, and may include additional components not specifically described in connection with FIGS. 1 and 2.

In some embodiments, data within data store 106 may be distributed among multiple physical servers. Thus, data store 106 may represent one or more physical storage locations, which may communicate with each other via the communications network and/or one or more other networks (not shown). In addition, server 110 as depicted in FIG. 2 may represent one or more physical servers, which may communicate with each other via communications network 109 and/or one or more other networks (not shown).

In one embodiment, some or all components of the system can be implemented in software written in any suitable computer programming language, whether in a standalone or client/server architecture. Alternatively, some or all components may be implemented and/or embedded in hardware.

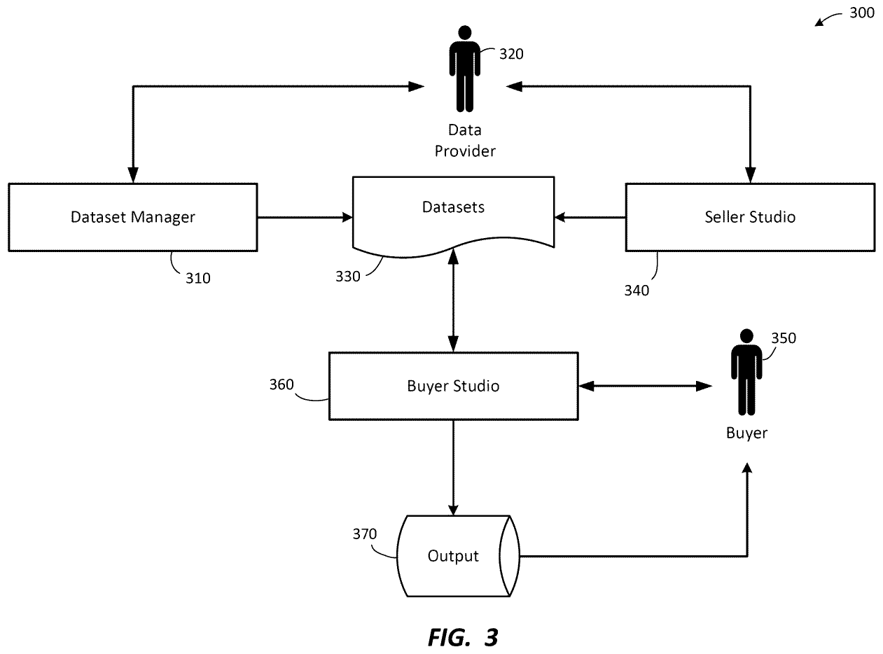

FIG. 3 depicts an example of an overall system architecture 300 according to one embodiment. One skilled in the art will recognize that the depicted architecture is merely exemplary, and that the techniques described herein can be implemented using other architectures.

In the exemplary embodiment of FIG. 3, Dataset Manager 310 is used by a data provider 320 to upload any number of datasets 330. In at least one embodiment, the system reads one or more files specified by data provider 320, and infers data types from the input file(s). For example, the system may make such determinations by identifying delimiters, escape characters, and/or the like. The system can also infer data types based on the content of the data, such as, for example, numeric, alphanumeric, timestamp, date, and/or the like. The supplier (e.g., data provider 320) can also specify a primary field that can be used to join the provided data with other available data.

Once dataset 330 has been uploaded, data provider 320 uses Seller Studio 340 to create one or more new data products. Data provider 320 selects which data products they wish to create, and selects a dataset 330 for each of the data products. Data provider 320 can choose which data columns, rows, or other fields are to be included, so as to create a data product that is likely to be of interest to a buyer 350. Data provider 320 can also specify any desired attributes for the data, and whether such attributes should be optional or mandatory. Data provider 320 can also set a price for the data and can specify whether the data should appear in the general marketplace or in the provider's own data shop. Data provider 320 can also specify how long the data product should be available. Finally, data provider 320 can name the data product, create a slug for it, and/or specify a URL.

Once a data product has been specified and activated, it will appear in any results for relevant searches by buyer 350. For example, a buyer 350 may activate Buyer Studio 360 to initiate a search for desired data. Buyer 350 need not specify a particular seller; rather, buyer 350 specifies particular attributes they are interested in. Once buyer 350 executes the search, the system retrieves all relevant data from all suitable sources, normalizing the retrieved data for buyer 350. This data, or a listing of it, may be provided as output 370 for buyer 350.

For example, buyer 350 may specify any number of data fields as deliverable and/or filterable. Buyer 350 may also specify whether the search should be applied to all data providers 320 or specific data providers 320 only, and can also specify where the data should be sent. Finally, buyer 350 can specify a budget, a frequency for receiving the data, and/or a payment method. If the resulting data exceeds the price buyer 350 is willing to pay, buyer 350 is given the opportunity to add filters, if desired, to reduce the size of the data product to be purchased, and thereby lower the price.

### User Interface

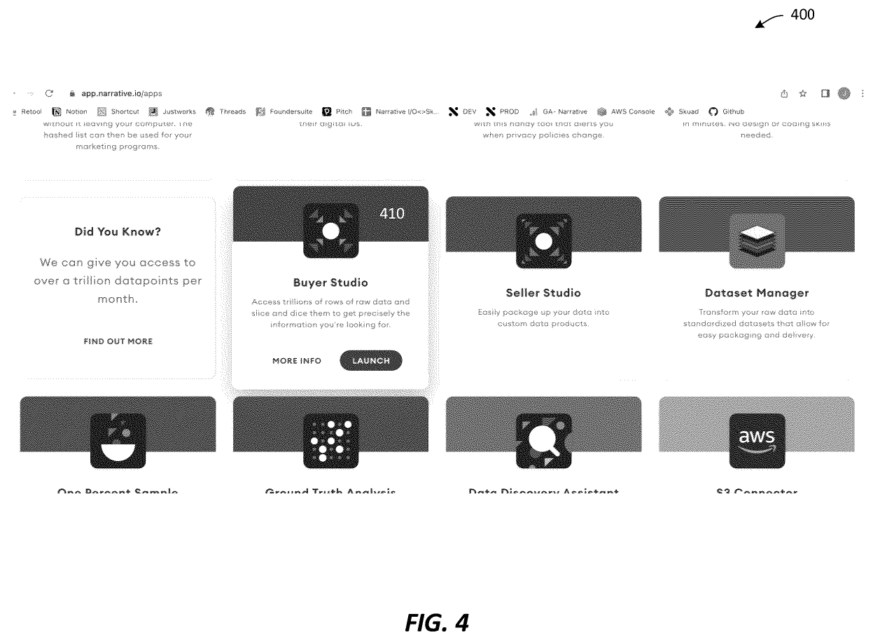

FIGS. 4 through 12 depict examples of screen shots that form part of a user interface for interacting with the described system, according to one embodiment.

As shown in a screenshot 400 in FIG. 4, buyer 350 (user) launches a software application for buying data by selecting an icon 410.

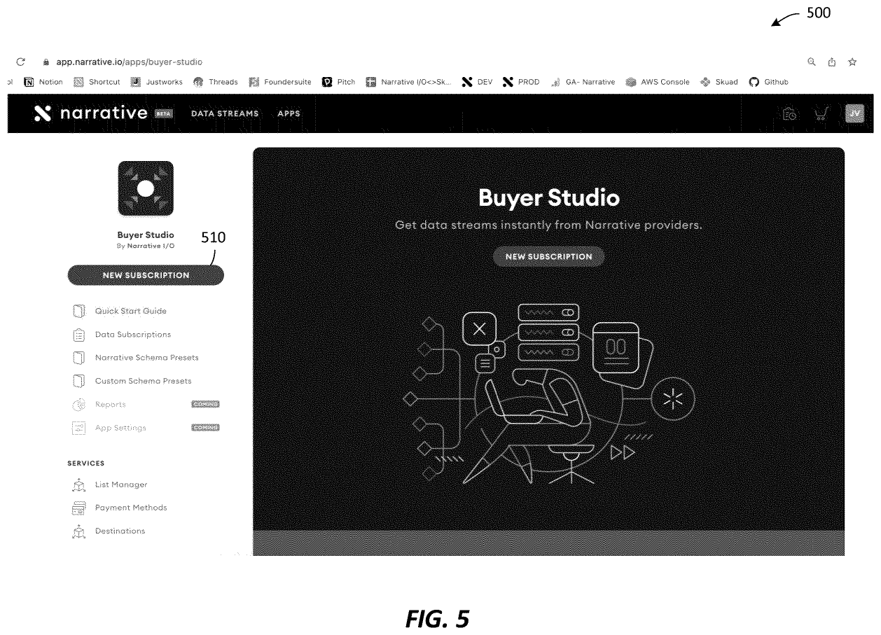

As shown in a screenshot 500 in FIG. 5, buyer 350 creates a new data subscription, for example, by selecting an icon 510. As a first step, buyer 350 selects attributes of interest, but need not specify which data providers 320 will provide the data, and need not specify particular data formats. Rather, buyer 350 specifies any number of attributes from a list that may be configurable by system administrators and/or other authorized individuals. In at least one embodiment, buyer 350 may create data products and/or subscriptions by interacting with a user interface, as described in more detail herein; alternatively, an API may be provided to allow buyer 350 to create and specify data products and/or subscriptions programmatically.

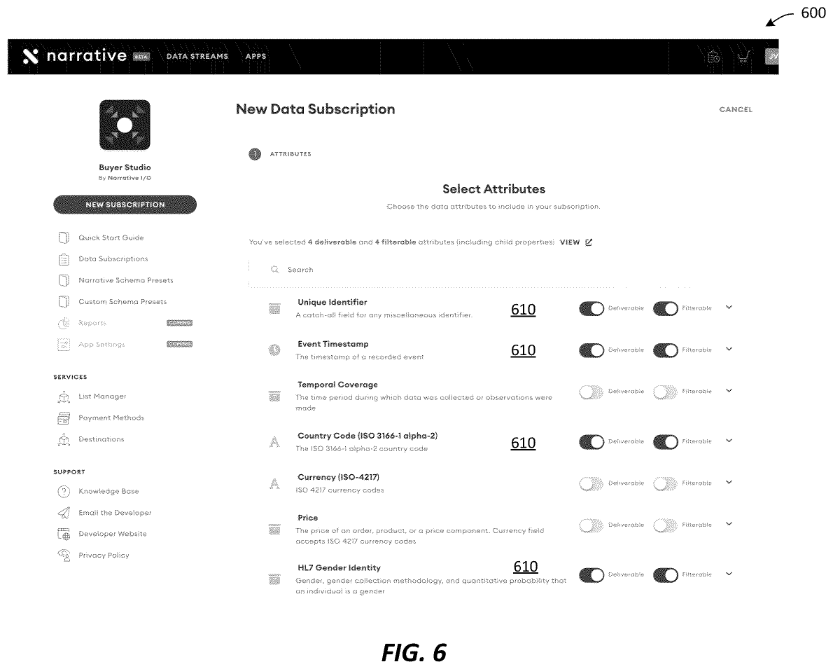

FIG. 6 depicts a screenshot 600 for a first step in creating a new data subscription. Buyer 350 can specify which attributes should be included as deliverable in the data subscription, and can also specify which attributes are filterable. In the example of FIG. 6, buyer 350 has specified that four attributes 610 should be both deliverable and filterable.

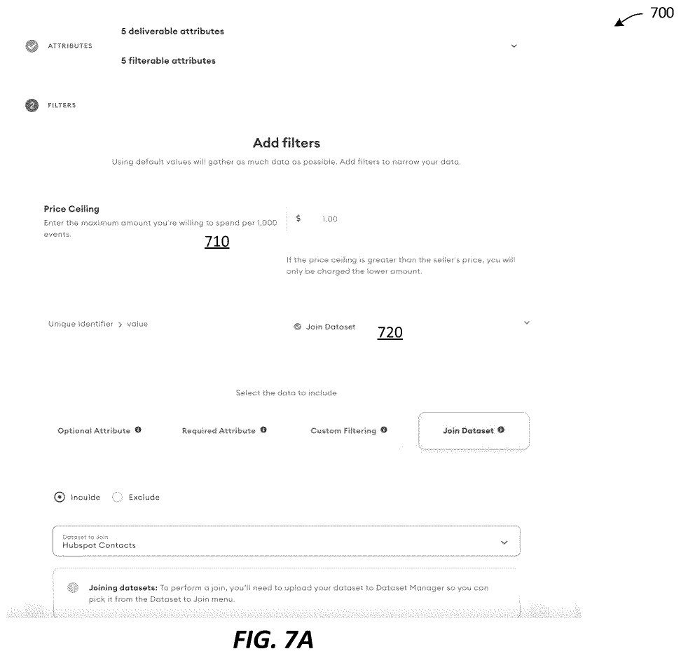

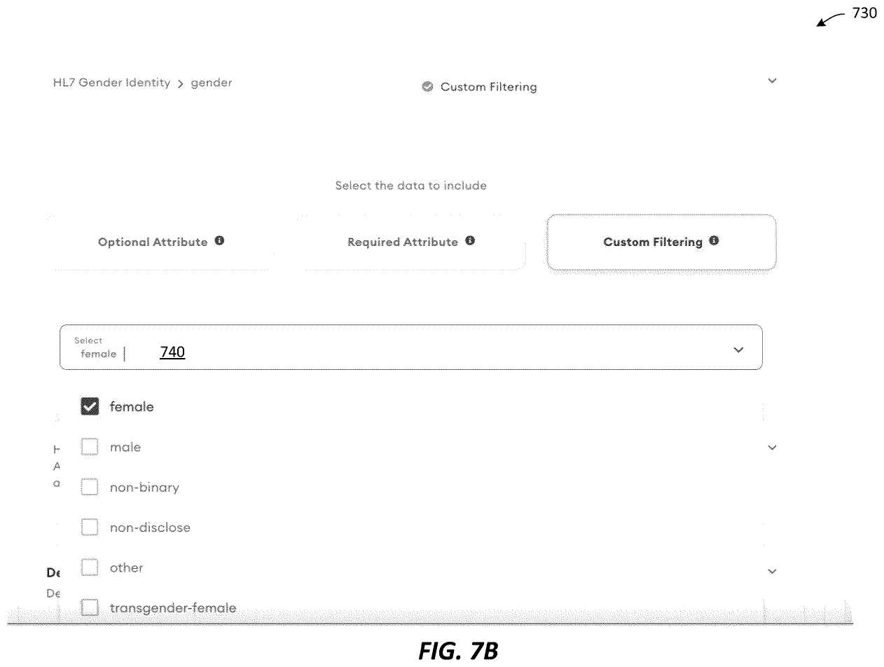

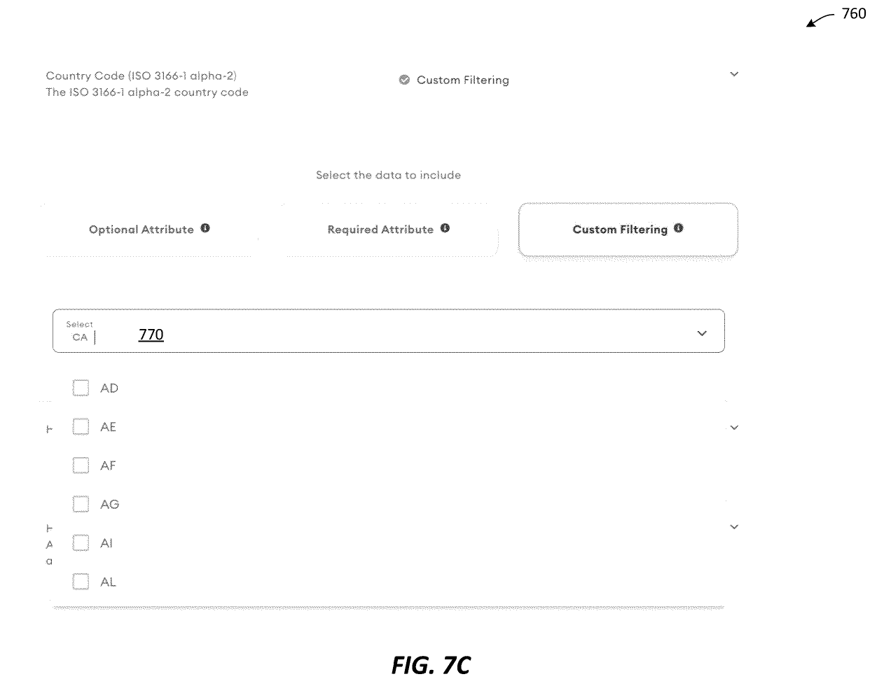

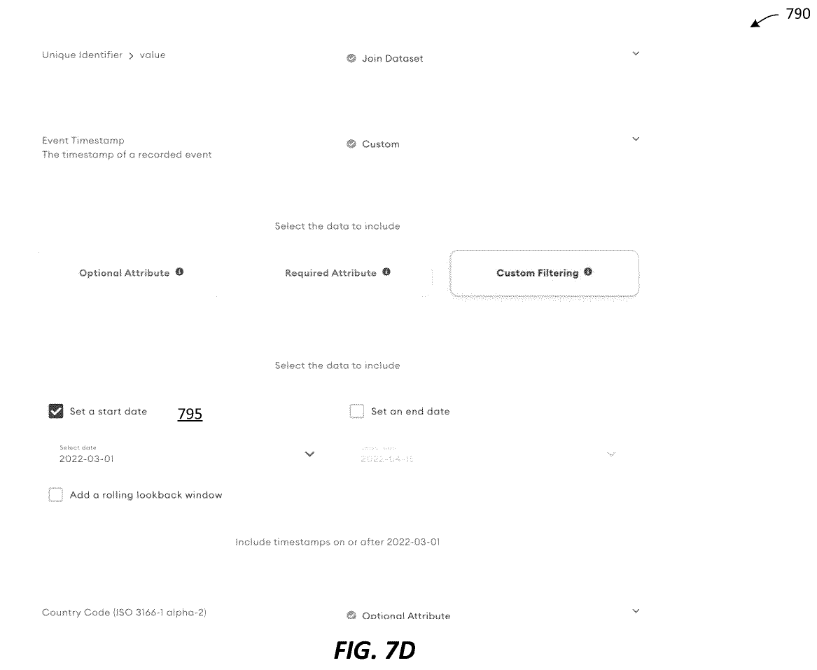

In FIGS. 7A through 7D, buyer 350 is prompted to specify filters and also to specify a maximum price they are will to pay for a given quantity of data, as shown in a screenshot 700, a screenshot 730, a screenshot 760, and a screenshot 790, respectively. In this example, buyer 350 has specified the following:
Price ceiling 710 of $1 per 1,000 rows;
Joining 720 of unique IDs across a network of data sellers to a list of customer email addresses;
Date range 795 from Mar. 1, 2022 to the present; and
Additional filters 740, 770 specifying: females in Canada having household income greater than $50,000.

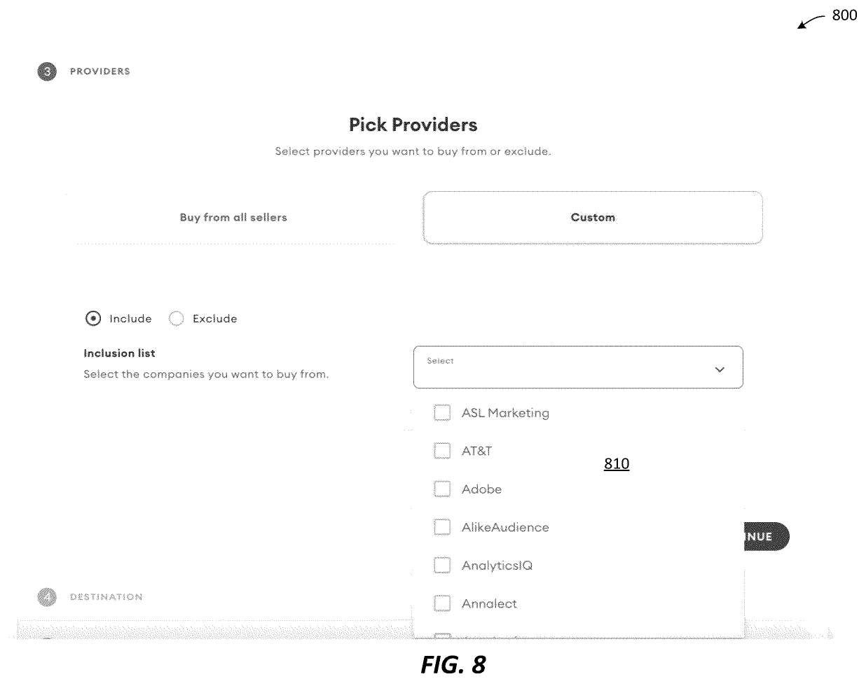

FIG. 8 depicts a screenshot 800 for a step in which buyer 350 can specify whether they wish to buy from all sellers or from specific sellers only. In at least one embodiment, buyer 350 may select specific companies 810 from whom they would like to buy data.

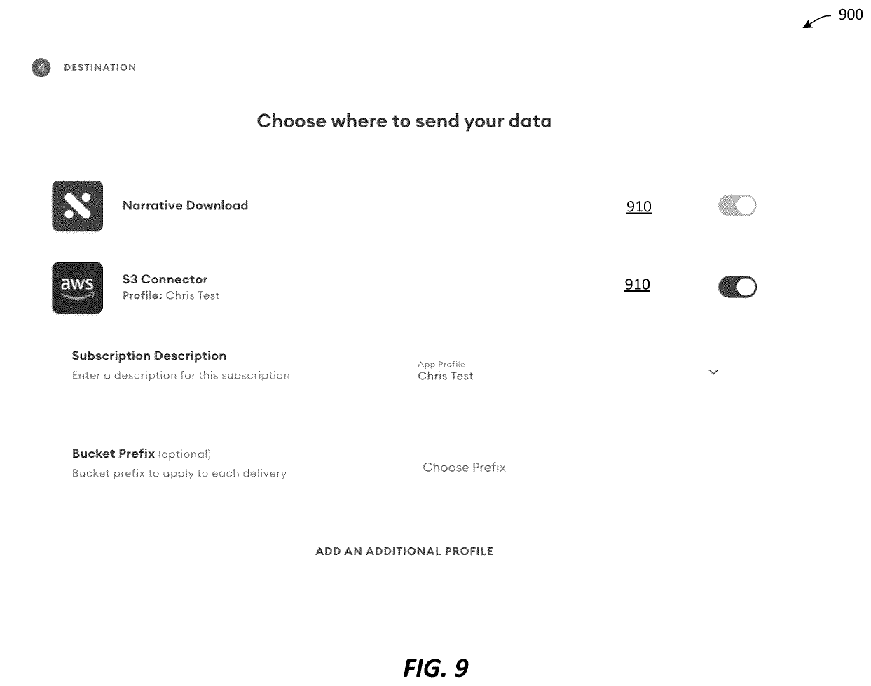

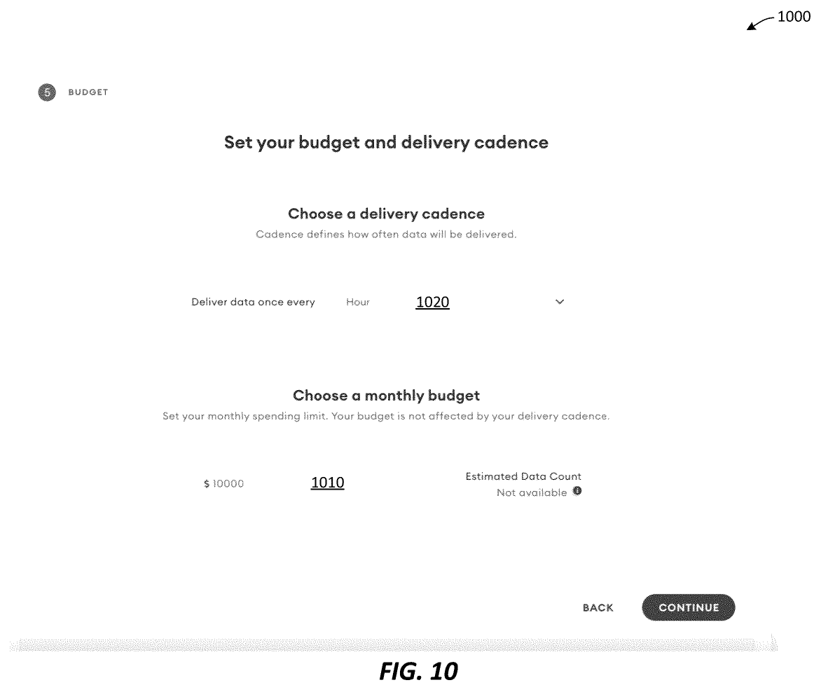

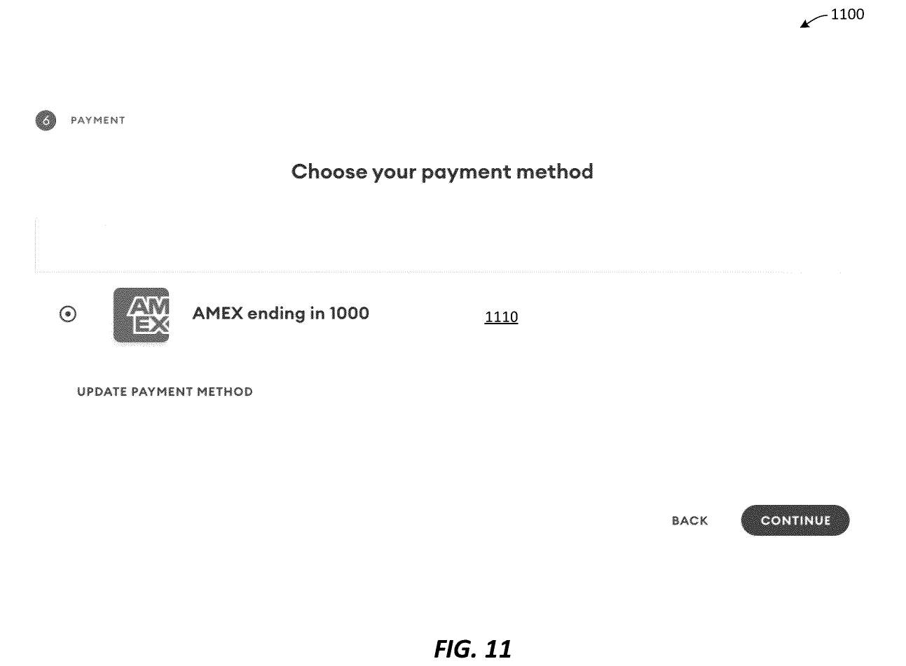

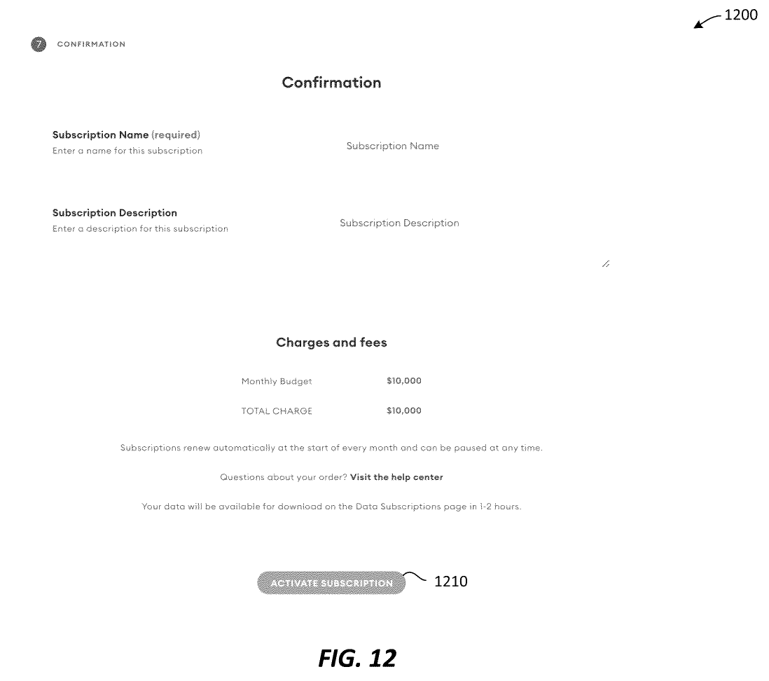

FIG. 9 depicts a screenshot 900 in which buyer 350 can specify one or more destinations 910 to which the resultant data should be delivered. FIG. 10 depicts a screenshot 1000 in which buyer 350 can specify a budget 1010 and frequency 1020 of data delivery. FIG. 11 depicts a screenshot 1100 in which buyer 350 can specify a payment method 1110. FIG. 12 depicts a screenshot 1200 in which buyer 350 can confirm the buy request, for example, by selecting an icon 1210. The request is then executed according to the specified parameters.

### EXAMPLE

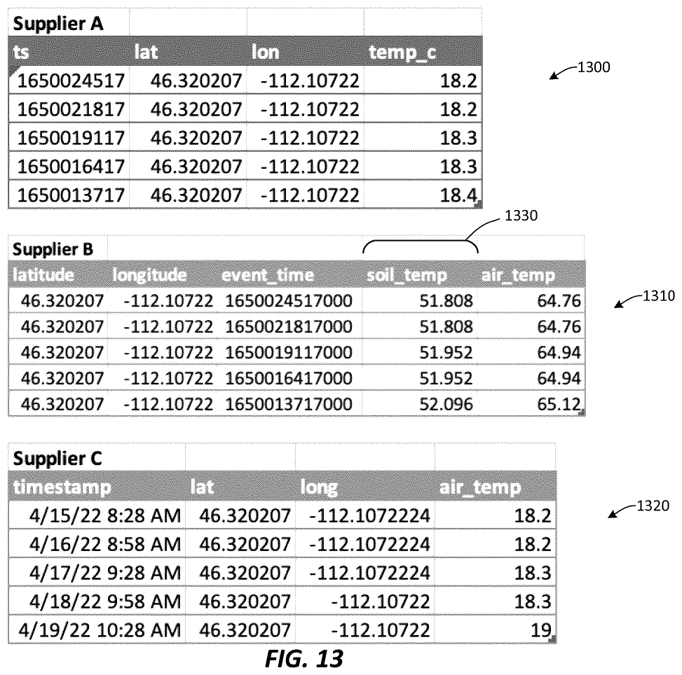

FIGS. 13 through 15 depict an example in which three suppliers have collected weather-related data and are making such data available using the described system.

In FIG. 13, the underlying tables 1300, 1310, 1320 from the three suppliers (i.e., providers) are shown. Each supplier is providing similar information; however, the information is stored in different formats. Supplier A encodes timestamps in seconds as shown in table 1300; Supplier B uses milliseconds as shown in table 1310; and Supplier C is using a non-standard format as shown in table 1320. In addition, Suppliers A and C are using Celsius for air temperature, while Supplier B is using Fahrenheit. Supplier B has also included an additional column 1330 (representing soil temperature) that is not included in the data from the other two suppliers.

The disparity in data and data formats is addressed by the techniques described herein, by providing a unified mechanism that allows buyer 350 to obtain data from different sources and encoded in different formats. Buyer 350 can define the dataset needed, and the system determines where to get the data and how to retrieve it across any number of data providers 320, tables, and/or data formats.

In the current example, buyer 350 can specify that they are interested in timestamp, latitude, longitude, and air temperature; the system generates a query based on buyer's 350 requirements, and normalizes the resulting dataset across all of the requested fields.

In SQL, the query generated by the system may be, for example:
‘select timestamp, latitude, longitude, air_temperature from narrative’

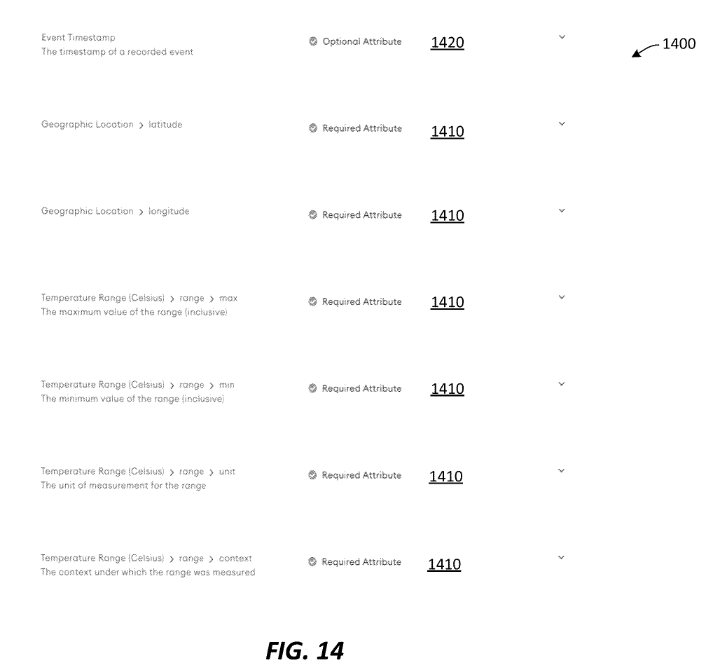

FIG. 14 is a screenshot 1400 depicting an example of a user interface for specifying the desired data. Latitude, longitude, maximum and minimum temperature, unit of measurement, and context are specified as required attributes 1410. Timestamp is specified as an optional attribute 1420.

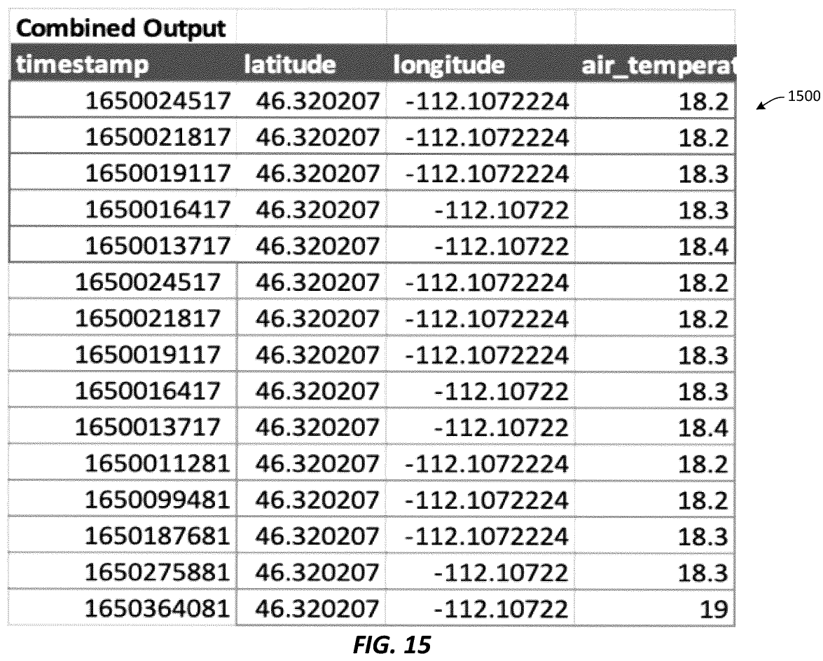

FIG. 15 depicts an example of output generated by the system in response to the query, shown in a table 1500 with data from table 1300, table 1310, and table 1320 of FIG. 13. As can be seen, the output includes data from all three suppliers, in a standardized format. In at least one embodiment, the provenance of the data is preserved so as to easily determine the source of each item in the output. This may be done, for example, by maintaining a source identifier or other field (not shown) for each row indicating which data provider 320 provided the data in that row.

### Implementation Details

In at least one embodiment, datasets are stored as Apache Iceberg tables. Apache Iceberg serves as the system that describes how and where data is stored physically, such as within a distributed object store, and also provides an interface to query execution engines that are used to retrieve dataset data.

In at least one embodiment, the system uses metadata given by data provider 320 at dataset creation to determine the physical layout of data to optimize query execution.

In at least one embodiment, a dataset management system can be provided to mediate access to datasets and to allow administrators to perform operations such as:
Changing the physical layout of data in datasets in order to respond to changing query patterns; and
Defining “materialized fields”, which are fields whose values are derived from provider dataset fields. Materialized fields serve to pre-calculate values that can be used to optimize data retrieval. In at least one embodiment, the expressions for producing materialized field values can be expressed in Structured Query Language (SQL).

Different data providers 320 may store dataset values in any of a number of different formats; therefore, the same underlying value may be encoded in a number of incongruous ways across different datasets. For example, one data provider 320 might represent a latitude in degrees, minutes, and seconds (e.g., 50° 40′46 N), while another might represent it in decimal degrees (e.g., 50.67944). Yet another data provider 320 might represent the same latitude in an entirely different coordinate system. Accordingly, in order to provide buyers 350 with consistent and comparable values for concepts such as latitude, the system allows for the definition of “attributes”, which catalog all data available in the system across all data providers 320 in a standardized format. In at least one embodiment, each attribute includes:
A name and/or identifier;
A schema, which may include a set of types associated with properties that define the structure of the attributes; and
A set of “validations”, which specify when a value matching the schema is semantically a valid instance of the attribute. For example, an attribute describing a latitude in decimal degrees must be a number between −90 and 90.

In at least one embodiment, the system includes an attribute management system that mediates access to attributes, allowing administrators to create, update, retrieve, and/or delete attributes. As new providers make new kinds of data available, new and existing attributes can be created and/or updated to model the data in a standardized way.

Given raw provider data in datasets and a set of attributes, the system is able to translate data from datasets into attributes via “mappings”. A mapping is a set of expressions (for example, defined in SQL) that transforms data points from a dataset to an attribute value. In at least one embodiment, a mapping management system allows mappings to be created, updated, deleted, and/or retrieved by system administrators who interpret provider data and specify how such data can be translated to relevant attributes.

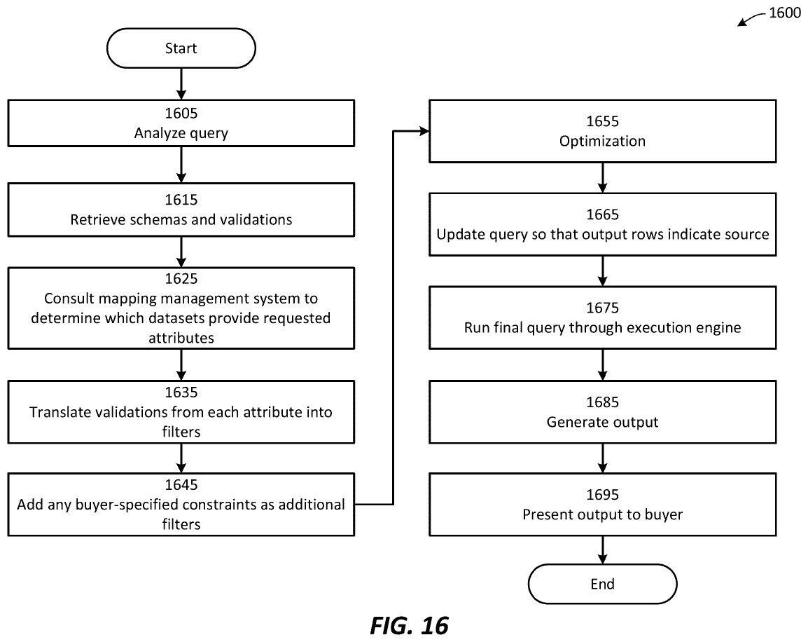

In at least one embodiment, a query compiler is provided, which receives a buyer's data query, expressed in terms of attributes, and translates it into an optimized query that can be efficiently executed by a distributed query execution engine, such as Apache Spark. FIG. 16 depicts an example of a method 1600 by which the query compiler services the buyer's query, as follows:
The query is analyzed 1605 to determine which attributes are being requested. The schemas and validations for the requested attributes are retrieved 1615 from the attribute management system.
The mapping management system is consulted 1625 to determine which datasets provide the requested attributes. With the relevant set of mappings in hand, the query compiler translates 1635 the mappings into the query execution engine's native query language.
For each attribute being requested, the query compiler translates its validations into a set of filters such that any mapped values that are not valid instances of an attribute are not returned. For example, if a mapping expression produces a latitude that is greater than 90 because data from a data provider 320 was flawed, then buyer 350 does not receive the corresponding row.
The compiler adds 1645 any constraints buyer 350 has expressed as additional filters to the query so buyer 350 only gets the attribute values they are looking for.
An optimization phase 1655 ensures that any buyer constraints are re-expressed in a form that allows the query execution engine to execute as efficiently as possible.
The query is updated 1665 in such a way that every output row contains a field indicating the dataset from which the row originated.
The final assembled query is run 1675 by the execution engine in coordination with the dataset management system (Apache Iceberg) to find all relevant data and generate output 1685.
The output is presented 1695 to buyer 350.

In at least one embodiment, the query results are made available to buyer 350 via a set of output files sent to a destination where buyer 350 can retrieve and analyze them.

The described system thus provides a way for data providers 320 to turn their datasets into prepackaged products that they can promote on their branded storefronts and/or on a centralized marketplace. These data products can then be purchased by buyers 350. A buyer 350 need not specify particular data providers 320, but can merely specify which attributes are of interest to them; the system then provides buyer 350 with all data that matches the specified attributes, regardless of source.

In at least one embodiment, data providers 320 can specify access rules to determine pricing, visibility, and/or licensing of their data as desired.

Buyers 350 can purchase data from providers via data products (also referred to as “data streams”) that have been made available on a centralized marketplace; such data products may have been created by providers directly or they may be provided by the system in an automated matter. Alternatively, buyers 350 may create their own desired data product(s) consisting of an arbitrary set of attributes and/or constraints on those attributes; pricing and licensing may be controlled by provider access rules.

Each access rule specified by a provider may include, for example:
An indication of the dataset to which is applies;
A list of companies for which the rule applies (or does not apply), specified via an inclusion/exclusion list;
A price at which to charge rows that match the access rule;
A licensing policy for rows that match the access rule;
A list of constraints on mapped attribute values that must be satisfied for the access rule to apply; and
The app for which the access rule applies.

An example of an access rule is as follows:
For Customer A, when attribute id has a type==md5_email, then charge $1 CPM and provide a 30-day license to use the data.

For a particular dataset, data provider 320 can specify the order in which access rules should be applied when determining which access rule to apply to a purchased row of data.

In at least one embodiment, a buyer 350 can purchase an arbitrary collection of attributes that are of interest, constraining attribute values to suit their needs. This is done by buyer 350 creating their own data product (data stream). Buyer 350 can:
Select which attributes should be included in the data product;
Specify which attributes and/or their properties are required or optional;
Filter attribute values using Spark SQL expressions;
Select attributes and/or attribute properties on which to deduplicate the output;
Define per-company inclusion/exclusion lists of datasets;
Define constraints on access rules that match the data product, including, for example: a minimum/maximum licensing period, a minimum/maximum price, and/or an inclusion/exclusion list of providers and/or datasets;
Define dataset-specific inclusion and exclusions; and/or
Define filters with respect to the age of data, where age is determined by when it was added to a dataset, such that they only receive data that meets their freshness criteria.

### Forecasting

In at least one embodiment, as buyer 350 defines constraints on their data product, the system provides real-time feedback as to how the defined constraints are affecting their data order even if the underlying datasets are large and querying them directly in real-time is infeasible or impractically expensive. “Access rules” may optionally be used to facilitate this. An access rule may be a primitive that allows a data provider 320 to specify who has access to their data and for what price. The buyer 350 then only needs to consider what attributes they want to purchase. The access rules may be evaluated “under the hood” (i.e., in a way that is transparent to the buyer 350) to determine which datasets satisfy the buyer's query.

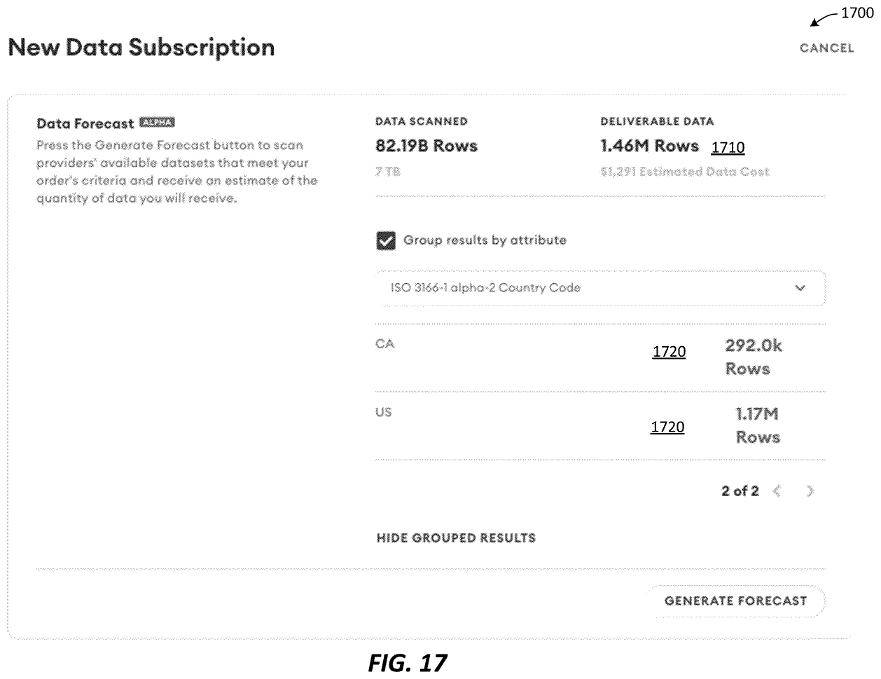

FIG. 17 is a screenshot 1700 depicting an example of a user using forecasting to determine the approximate number of rows 1710 that match their query. According to this example, there are multiple data providers 1720, each with datasets containing sales history for different ISBNs of books.

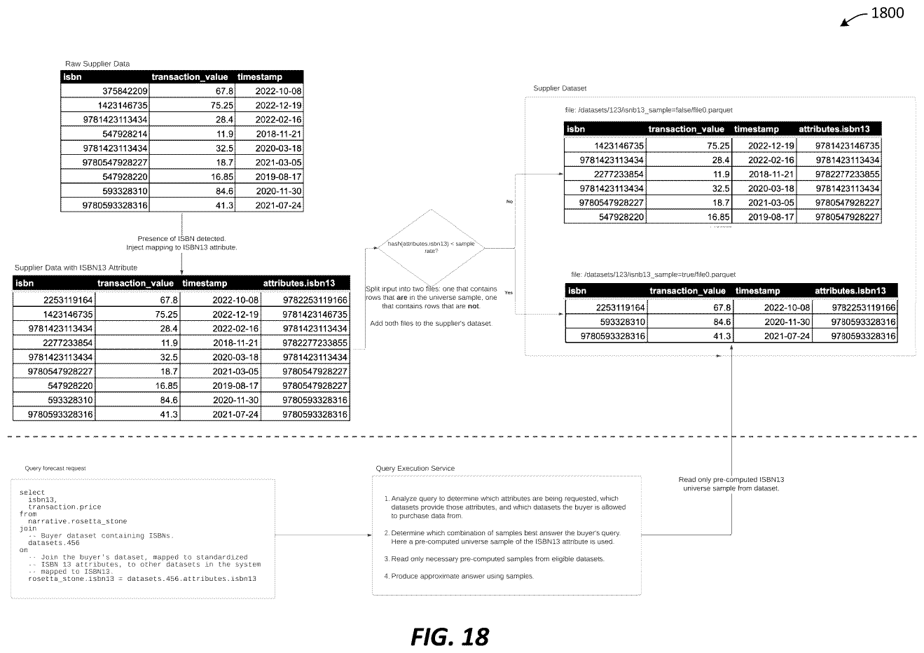

FIG. 18 is a schematic flow diagram 1800 showing how forecasting may be carried out, according to one embodiment.

The system may automatically map the provider data to the “ISBN” attribute. Using historical query patterns, the system may recognize that buyers 350 are interested in data for specific ISBNs. In order to make forecasts accurate, the system may pre-calculate a universe sample of all ISBNs in the input provider data when data is added to datasets.

In at least one embodiment, the system may enable this functionality via pre-calculation of relevant samples (described below) as “materialized fields” (previously defined) and exploiting them when processing a forecast request. In at least one embodiment, the following procedure may be used:
1. The dataset management system, or a system administrator using the dataset management system, analyzes the dataset, taking into consideration the schema of the dataset, the attributes to which it is mapped, historical query patterns for both the dataset itself and the attributes present in the dataset and uses this information to determine which samples of fields might be useful in answering aggregate queries against the dataset. For example, if a “country_code” is often used in “group by” queries (in the traditional SQL sense), the system can determine that a stratified sample of the “country_code” field should be calculated so that each distinct country code in the dataset is adequately represented in the sample, enabling more accurate aggregation when country_code is used as a dimension.
2. The dataset management system pre-calculates the samples as materialized fields. Here, “pre-calculation” may refer to grouping together rows that are part of a sample into a small set of files such that every row in the file group is part of a given sample. One way to do this is by turning samples into boolean-valued materialized fields, where the field has a value of “true” if a row appears in the relevant sample and a value of “false” if it does not, with the dataset management system ensuring that all rows in a file all have the same values (i.e. all rows are in the sample, or all rows are not in the sample). FIG. 18 demonstrates this process: the raw supplier data is split into multiple groups of files: one where isbn13_sample is true (with storage path/datasets/123/isbn13_sample=true/) and one where isbn13_sample is false (with storage path (/datasets/123/isbn13_sample=false). The dataset management system stores the type of sample a materialized field represents as well as additional metadata such as the sample rate.
3. When the query execution service is processing a forecasting request, it goes through the usual process of determining which datasets match the query as demonstrated in FIG. 16. In the optimization phase 1655, it does the following for each participating dataset:
   a) It consults the dataset management system to determine what materialized fields that dataset has and which of those fields correspond to pre-calculated samples.
   b) It determines which pre-calculated samples are relevant for the given query. This process is based on heuristics and rules, e.g. if a user is grouping by a field for which there exists a materialized field representing a stratified sample of that field, the system will choose to use that sample.
   c) It optimizes the query to only read files that belong to the pre-calculated samples it has determined best answer the given query. In the example given in FIG. 18, it can do so by only reading files where the storage path includes “isbn13_sample=true”.
4. The query is executed against the files in the relevant samples and the final results are re-scaled to take into account the fact that the query was executed against a sample. For example, if the forecasting system queried only a single sample that represented a Bernoulli sample of the dataset with a sample rate of 0.1 and found 1,000,000 rows matching the buyer's query, the query execution service can choose to multiply 1,000,000 by 10 (10=1/the sample rate) to estimate that 10,000,000 rows in the whole dataset match the buyer's query.

FIG. 18 demonstrates this process end to end. First, the system may automatically map the provider data to the “ISBN” attribute. Using historical query patterns, the system may recognize that buyers 350 are interested in data for specific ISBNs. In order to make forecasts accurate, the system may pre-calculate a universe sample of all ISBNs in the input provider data when data is added to datasets.

A “universe sample” is a sample of values for an attribute that is representative of the attribute's overall distribution. It is generated by applying a hash function to the values in the column and selecting all rows that hash to a value within a specified range (determined by the target sample rate). The use of a universe sample is important because book sales are not evenly distributed across ISBNs and there may be rare or uncommon ISBNs that are important to capture in the sample. “Pre-calculation” is as defined above, resulting in all rows that are part of the “universe sample” of ISBN values being clustered together into a small set of files. The advantage of doing this is that when the query system is to execute a query against a universe sample of the ISBN values, it may only read a subset of the dataset.

A buyer 350 who is running a bookstore may have a large list of ISBNs that they are interested in, and they may want to know how many of those ISBNs have transaction data available in the system. FIG. 18 shows that when buyer 350 submits a forecast request, the query compilation system can exploit the fact that there is a pre-calculated universe sample of ISBN values. It may only read files in the universe sample to approximate the number of matches.

Note that the system need not be restricted to sampling a single field using a single sampling strategy. In some embodiments, it can pre-calculate samples of any number of attributes using any sampling strategy such as Bernoulli or stratified sampling. These samples can be combined and leveraged at query time to generate an accurate and timely forecasted answer.

### Joins

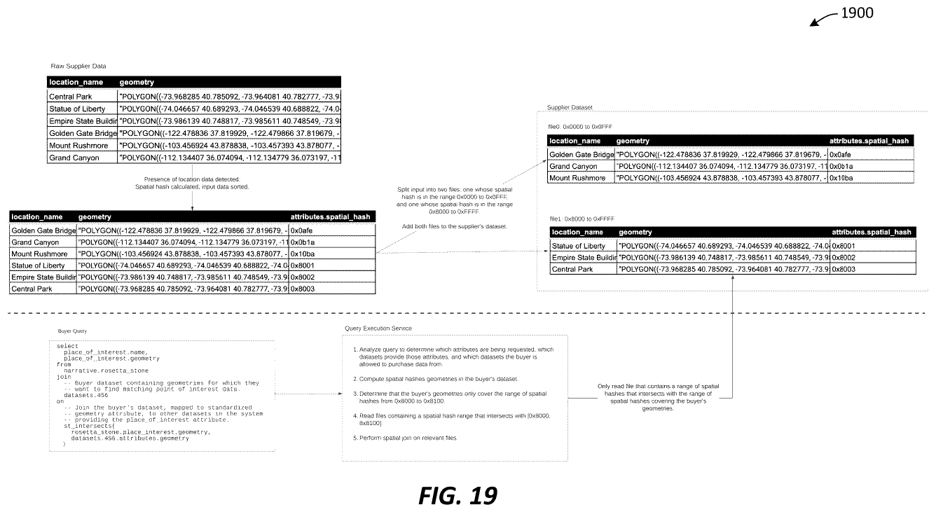

In some embodiments, buyers 350 can join their datasets to supplier datasets such that they only purchase data which matches their own. FIG. 19 is a schematic flow diagram 1900 showing how joining may be carried out, according to one embodiment. Different join strategies may be available, including but not limited to:
A simple equality join;
An equality anti-join where a buyer 350 only purchases data that does not match data in their datasets; and/or
Spatial joins that allow a buyer 350 to purchase supplier data that geographically intersects with or is contained within their own. For example, a buyer 350 can purchase supplier rows with longitude, latitude pairs that are contained within polygons in buyer's 350 dataset.

To make spatial joins efficient, the system may use a process called “spatial indexing.” In one embodiment, this may be done as follows:
1. The dataset management system, or a system administrator using the dataset management system, analyzes a dataset and determines whether it contains rows with a geometry-like attribute. The geometry-like attribute could be a polygon expressed in the Well-known Text geometry representation (WKT), GeoJSON, a location specified by a longitude and latitude, or similar.
2. If the presence of a geometry-like attribute is detected, the dataset management system creates a materialized field which represents a “spatial hash” of the geometry-like value. A “spatial hash” is an embedding of the multi-dimensional geometries onto a one-dimensional line with the property that geometries that are in close physical proximity with respect to the multi-dimensional coordinate system in which they are defined are also close in the one-dimensional representation. Examples of spatial hashes include the geohash and the extended Z-ordering. The resulting one-dimensional value for each geometry is called a “spatial hash key.” This is depicted in FIG. 19, where raw seller data containing a geometry expressed in WKT has been detected to be “geometry-like” and the dataset management system has calculated a spatial hash for each row.
3. Given the presence of a spatial hash materialized field, the dataset management system chooses to sort the supplier's data according to the spatial hash value. The sorted output may consist of one or more files, depending on the size of the input. If there is more than one file in the output, the dataset management system ensures that the following invariant holds: each file contains a contiguous range of spatial hashes that does overlap with the range contained in any other file. This is shown in FIG. 19, where file0 contains supplier data with a spatial hash between the values of 0x0000 and 0x0FFF and file1 contains supplier data with a spatial hash between the values of 0x8000 and 0xFFFF. The dataset management service keeps track of which files contain which ranges of spatial hashes so that this information can be used by the query execution service. For the materialized field representing the spatial hash, the dataset management system also tracks which algorithm was used to produce the hash (e.g. geohash).
4. When a buyer 350 wants to find data associated with geometries that intersect with places that are of interest to them, the query execution system goes through the usual process of determining which datasets match the query as demonstrated in FIG. 16. In the optimization phase 1655, it does the following for each participating dataset:
   a) It consults the dataset management system to determine which materialized fields the dataset has and if any of them correspond to a spatial hash.
   b) If the dataset contains a materialized field representing a spatial hash, the query execution system applies the same spatial hash to the buyer's geometries in order to determine the range of spatial hashes covered by the buyer's data. In FIG. 19, e.g., it determines that the buyer's geometries cover the spatial hash range 0x8000 to 0x8100.
   c) The query execution service then includes a range query against the spatial hash materialized field that excludes any supplier data with a spatial hash that falls outside the range covered by the buyer's data. Taking FIG. 19 for example, the query execution system would include a filter that ensures that attributes.spatial_hash is >=0x8000 and <=0x8100 because the buyer's data covers the spatial hash range 0x8000 to 0x8100.
   d) Because the dataset management service keeps track of which files contain which ranges of spatial hashes, the query execution can use the injected spatial range query to determine which files are guaranteed to not intersect with the buyer's geometries based on the spatial hash range they cover. For example, in FIG. 19 the query execution service knows to skip file0 because it contains spatial hashes are in the range 0x0000 to 0x0FFF which does not overlap with the range covered by the buyer's geometries (0x8000 to 0x81000). This makes the overall join more efficient because the query execution system does not have to read those files from storage: it knows at optimization time that those files cannot possibly contain any data that satisfies the buyer's query.
   e) Finally, the query execution system may perform a spatial join by comparing the geometries in the files that pass the filter injected in the previous step with buyer's 350 geometries to find matching rows.

Using this technique, the system may be able to efficiently perform spatial joins even on very large datasets with millions or billions of rows without having to process all of the data in the datasets.

In at least one embodiment, buyer-created data products are not made available on the centralized marketplace.

A data product specified by buyer 350 can be used to create a subscription. The subscription can then be used to provide an ongoing source of data to the buyer 350. In at least one embodiment, a subscription includes:
A name, description, and/or status;
A set of attributes, attribute constraints, access rule constraints, and/or the like that were used to specify the data product;
A budget;
A period, such as daily, weekly, monthly, and/or the like; and
The app from which it was created.

The creation of a subscription and data product can be expressed, for example, in terms of a variant of SQL:

```
SELECT
  sha256_hashed_email,
  mobile_unique_identifier
FROM
  narrative.rosetta_stone
WHERE
  event_timestamp > “2023-02-01”
  AND mobile_unique_identifier.type = “IDFA”
  AND _price_cpm < 2.0
LIMIT
  50 USD PER CALENDAR_MONTH
```

The system may infer from the SQL which attributes are being purchased, which constraints are applied, and other subscription details such as buyer's 350 budget.

In at least one embodiment, a data product that a buyer 350 has chosen to include in a subscription can be used as a template rather than being directly referenced. This allows buyer 350 to modify the constraints included in the data product in the future.

In at least one embodiment, buyers 350 can also create their own ad hoc data products for a subscription, without needing to use an ID.

In at least one embodiment, a buyer 350 can execute a one-time (or limited-time) purchase of a data product. In such a case, the system can read from datasets until it is able to generate a snapshot of relevant data after the creation time of the subscription. Once the specified criteria for the data product have been satisfied, so that there is no more data to be read that fits the criteria, the subscription can be marked as “completed”.

In at least one embodiment, buyers 350 can browse and search for attributes to be included in the data products they wish to create, based on what is available in the data marketplace. Buyers 350 can search for attributes by name, description, tags, and/or other fields, and can also view other attribute metadata, such as validation expressions. Buyers 350 can also see which datasets provide a particular attribute, and which access rules govern pricing and licensing of attribute values from each provider.

In at least one embodiment, the system informs buyer 350 as to whether the combination of attributes they have specified can be purchased together, so that buyer 350 can avoid building a data product for which there are no providers (or for which there is no available data). For example, as buyer 350 selects attributes to make up their data product, the system can show other attributes that are also available to be selected, based on compatibility with previous selections. If a combination of attributes would result in no dataset being mapped, buyer 350 can be warned of such an occurrence, or the combination can be disallowed or made unavailable.

In at least one embodiment, the system can present example values of attribute properties so as to provide buyer 350 with guidance as to how to build constraints for the data product. For example:
/attributes/id/type/values can provide accepted values for the property type of the id attribute, where type has an “enum” with valid values.
For a purchasedItem attribute with a brand property that is a string-type property without an “enum”, the system may present to buyer 350 available name property values of the purchasedItem attribute where brand contains area or Nabisco.

In at least one embodiment, the system allows buyer 350 to create data products that include an arbitrary set of attributes and attribute constraints from any provider or set of providers, and to make such data products available as part of a centralized marketplace or within an app.

In at least one embodiment, system administrators have access to all options that are available to buyer 350, and can also add a name, product picture, description, and specification of which app the data product will be available on.

In at least one embodiment, the system can provide data providers and/or system administrators with reports indicating who is purchasing which datasets and which data products, regardless of who created them. The system can also provide information as to the amount of revenue each data product is generating, for tracking purposes and to enable assessment of the health of the marketplace.

### Access Rules

In at least one embodiment, for a buyer-created data product, a parameter entitled access_rule_constraints specifies which access rules apply to the data product. Other eligibility criteria can also be applied.

In at least one embodiment, for a system-generated data product, a visibility parameter can be set to app_id; if so, then app-specific access rules are applied first.

In at least one embodiment, for provider-generated data products, in-lined access rules apply to all rows in all eligible datasets, so that data provider 320 need not specify one for each dataset. By providing access rules in an in-lined manner, the price and licensing parameters can be made explicit and immutably tied to the data product for its lifetime.

In at least one embodiment, when a subscription is generated from a buyer-created data product, most of the fields can be copied directly from the data product. For a subscription generated from a system-created data product, a pointer back to the original data product can be included. For a subscription generated from a provider-created data stream, access rules for the data product can be provided in in-lined, immutable form. Other configurations and implementations may allow access rules to be changed by authorized individuals.

### Schema Inference

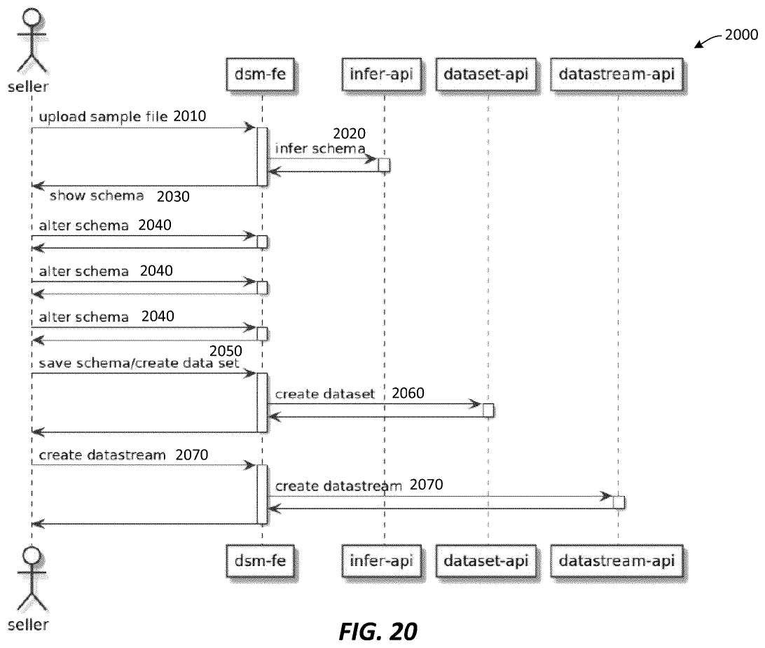

FIG. 20 is a schematic diagram 2000 that depicts an example of a method for schema inference according to one embodiment. Data provider 320 uploads 2010 a sample file, and the system infers 2020 a schema which is then shown 2030 to data provider 320. If necessary, the schema may be altered 2040 as needed based on provider input and/or other factors. The schema is then saved 2050.

Next, the dataset is created 2060 using an appropriate API, as described above. Finally, a data product (or data stream) is created 2070 using an appropriate API.

The present system and method have been described in particular detail with respect to possible embodiments. Those of skill in the art will appreciate that the system and method may be practiced in other embodiments. First, the particular naming of the components, capitalization of terms, the attributes, data structures, or any other programming or structural aspect is not mandatory or significant, and the mechanisms and/or features may have different names, formats, or protocols. Further, the system may be implemented via a combination of hardware and software, or entirely in hardware elements, or entirely in software elements. Also, the particular division of functionality between the various system components described herein is merely exemplary, and not mandatory; functions performed by a single system component may instead be performed by multiple components, and functions performed by multiple components may instead be performed by a single component.

Reference in the specification to “one embodiment” or to “an embodiment” means that a particular feature, structure, or characteristic described in connection with the embodiments is included in at least one embodiment. The appearances of the phrases “in one embodiment” or “in at least one embodiment” in various places in the specification are not necessarily all referring to the same embodiment.

Various embodiments may include any number of systems and/or methods for performing the above-described techniques, either singly or in any combination. Another embodiment includes a computer program product comprising a non-transitory computer-readable storage medium and computer program code, encoded on the medium, for causing a processor in a computing device or other electronic device to perform the above-described techniques.

Some portions of the above are presented in terms of algorithms and symbolic representations of operations on data bits within a memory of a computing device. These algorithmic descriptions and representations are the means used by those skilled in the data processing arts to convey the substance of their work most effectively to others skilled in the art. An algorithm is here, and generally, conceived to be a self-consistent sequence of steps (instructions) leading to a desired result. The steps are those requiring physical manipulations of physical quantities. Usually, though not necessarily, these quantities take the form of electrical, magnetic or optical signals capable of being stored, transferred, combined, compared and otherwise manipulated. It is convenient at times, principally for reasons of common usage, to refer to these signals as bits, values, elements, symbols, characters, terms, numbers, or the like. Furthermore, it is also convenient at times, to refer to certain arrangements of steps requiring physical manipulations of physical quantities as modules or code devices, without loss of generality.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “displaying” or “determining” or the like, refer to the action and processes of a computer system, or similar electronic computing module and/or device, that manipulates and transforms data represented as physical (electronic) quantities within the computer system memories or registers or other such information storage, transmission or display devices.

Certain aspects include process steps and instructions described herein in the form of an algorithm. It should be noted that the process steps and instructions can be embodied in software, firmware and/or hardware, and when embodied in software, can be downloaded to reside on and be operated from different platforms used by a variety of operating systems.

The present document also relates to an apparatus for performing the operations herein. This apparatus may be specially constructed for the required purposes, or it may comprise a general-purpose computing device selectively activated or reconfigured by a computer program stored in the computing device. Such a computer program may be stored in a computer readable storage medium, such as, but is not limited to, any type of disk including floppy disks, optical disks, CD-ROMs, DVD-ROMs, magnetic-optical disks, read-only memories (ROMs), random access memories (RAMs), EPROMs, EEPROMs, flash memory, solid state drives, magnetic or optical cards, application specific integrated circuits (ASICs), or any type of media suitable for storing electronic instructions, and each coupled to a computer system bus. Further, the computing devices referred to herein may include a single processor or may be architectures employing multiple processor designs for increased computing capability.

The algorithms and displays presented herein are not inherently related to any particular computing device, virtualized system, or other apparatus. Various general-purpose systems may also be used with programs in accordance with the teachings herein, or it may prove convenient to construct more specialized apparatus to perform the required method steps. The required structure for a variety of these systems will be apparent from the description provided herein. In addition, the system and method are not described with reference to any particular programming language. It will be appreciated that a variety of programming languages may be used to implement the teachings described herein, and any references above to specific languages are provided for disclosure of enablement and best mode.

Accordingly, various embodiments include software, hardware, and/or other elements for controlling a computer system, computing device, or other electronic device, or any combination or plurality thereof. Such an electronic device can include, for example, a processor, an input device (such as a keyboard, mouse, touchpad, track pad, joystick, trackball, microphone, and/or any combination thereof), an output device (such as a screen, speaker, and/or the like), memory, long-term storage (such as magnetic storage, optical storage, and/or the like), and/or network connectivity, according to techniques that are well known in the art. Such an electronic device may be portable or non-portable. Examples of electronic devices that may be used for implementing the described system and method include: a mobile phone, personal digital assistant, smartphone, kiosk, server computer, enterprise computing device, desktop computer, laptop computer, tablet computer, consumer electronic device, or the like. An electronic device may use any operating system such as, for example and without limitation: Linux; Microsoft Windows, available from Microsoft Corporation of Redmond, Washington; MacOS, available from Apple Inc. of Cupertino, California; iOS, available from Apple Inc. of Cupertino, California; Android, available from Google, Inc. of Mountain View, California; and/or any other operating system that is adapted for use on the device.

While a limited number of embodiments have been described herein, those skilled in the art, having benefit of the above description, will appreciate that other embodiments may be devised. In addition, it should be noted that the language used in the specification has been principally selected for readability and instructional purposes, and may not have been selected to delineate or circumscribe the subject matter. Accordingly, the disclosure is intended to be illustrative, but not limiting, of scope.

What is claimed is:

1. A computer-implemented method for managing access to data over a network, the method comprising:
at a first hardware processing device, automatically reading a first dataset to infer one or more data types of data within the first dataset;
at a communication device, making a data product available over the network, the data product comprising at least part of the first dataset;
at an input device, receiving, from a user, a first search query specifying one or more attributes of data desired by the user, wherein the attributes are based on the data types;
at a second hardware processing device connected to the network, responsive to the first search query, identifying a first subset of the first dataset, wherein the first subset possesses the attributes; and
at an output device, displaying results of the first search query for the user.

2. The method of claim 1, wherein inferring the one or more data types comprises identifying delimiters within the first dataset to divide the first dataset into a plurality of fields.

3. The method of claim 2, wherein inferring the data types further comprises examining contents of one or more of the fields to determine that the contents have a common data type.

4. The method of claim 1, wherein making the data product available over the network comprises including a second dataset in the data product, the second dataset being from a different provider from the first dataset.

5. The method of claim 4, wherein making the data product available over the network comprises normalizing a first field of the first dataset with a second field of the second dataset to facilitate comparison, by the user, of the first field with the second field.

6. The method of claim 1, wherein making the data product available over the network comprises excluding one or more fields of the first dataset from the data product.

7. The method of claim 1, wherein making the data product available over the network comprises establishing a price for use, by the user, of the data product.

8. The method of claim 1, wherein the one or more attributes comprise a field of interest to the user.

9. The method of claim 8, wherein receiving the first search query comprises receiving an indication, from the user, that the field of interest is to be filterable.

10. The method of claim 1, wherein receiving the first search query comprises receiving, from the user, an identity of a provider of data of interest to the user.

11. The method of claim 1, wherein receiving the first search query comprises receiving, from the user, a budget indicative of how much the user is willing to pay for use of the data product.

12. The method of claim 1, further comprising, after displaying the results of the first search query:
receiving, at the input device, a second search query;
at the second hardware processing device, responsive to the second search query, identifying a second subset of the first subset of the first dataset; and
at the output device, displaying results of the second search query for the user.

13. The method of claim 1, further comprising, after displaying the results of the first search query, receiving, at the input device, user input indicating a desire to purchase use of the first subset.

14. The method of claim 1, further comprising:
at the second hardware processing device, responsive to the first search query, generating a forecast indicating a size of the first subset and/or a likely cost for use, by the user, of the first subset; and
at the output device, displaying the forecast for the user.

15. The method of claim 1, further comprising, at the second hardware processing device:
comparing the first dataset with a second dataset provided by the user; and
joining the first dataset with the second dataset to generate a second subset of the first dataset that does not overlap with the second dataset.

16. The method of claim 1, further comprising, at the second hardware processing device:
comparing the first dataset with a second dataset provided by the user; and
joining the first dataset with the second dataset to generate a second subset of the first dataset that overlaps with the second dataset.

17. The method of claim 1, further comprising, at the second hardware processing device:
comparing the first dataset with a second dataset provided by the user; and
joining the first dataset with the second dataset to generate a second subset of the first dataset that intersects with the second dataset.

18. A non-transitory computer-readable medium for managing access to data over a network, comprising instructions stored thereon, that when performed by a processor, perform the steps of:
causing a first hardware processing device to automatically read a first dataset to infer one or more data types of data within the first dataset;
causing a communication device to make a data product available over the network, the data product comprising at least part of the first dataset;
causing an input device to receive, from a user, a first search query specifying one or more attributes of data desired by the user, wherein the attributes are based on the data types;
causing a second hardware processing device connected to the network, responsive to the first search query, to identify a first subset of the first dataset, wherein the first subset possesses the attributes; and
causing an output device to display results of the first search query for the user.

19. The non-transitory computer-readable medium of claim 18, wherein inferring the one or more data types comprises:
identifying delimiters within the first dataset to divide the first dataset into a plurality of fields; and
examining contents of one or more of the fields to determine that the contents have a common data type.

20. The non-transitory computer-readable medium of claim 18, wherein making the data product available over the network comprises:
including a second dataset in the data product, the second dataset being from a different provider from the first dataset; and
normalizing a first field of the first dataset with a second field of the second dataset to facilitate comparison, by the user, of the first field with the second field.

21. The non-transitory computer-readable medium of claim 18, wherein making the data product available over the network comprises at least one of:
excluding one or more fields of the first dataset from the data product; and
establishing a price for use, by the user, of the data product.

22. The non-transitory computer-readable medium of claim 18, wherein:
the one or more attributes comprise a field of interest to the user; and
receiving the first search query comprises receiving an indication, from the user, that the field of interest is to be filterable.

23. The non-transitory computer-readable medium of claim 18, wherein receiving the first search query comprises receiving, from the user, a budget indicative of how much the user is willing to pay for use of the data product.

24. The non-transitory computer-readable medium of claim 18, further comprising instructions stored thereon, that when performed by a processor, after displaying the results of the first search query, perform the steps of:
causing the input device to receive a second search query;
causing the second hardware processing device, responsive to the second search query, to identify a second subset of the first subset of the first dataset; and
causing the output device to display results of the second search query for the user.

25. The non-transitory computer-readable medium of claim 18, further comprising instructions stored thereon, that when performed by a processor, after displaying the results of the first search query, cause the input device to receive user input indicating a desire to purchase use of the first subset.

26. The non-transitory computer-readable medium of claim 18, further comprising instructions stored thereon, that when performed by a processor, perform the steps of:
causing the second hardware processing device, responsive to the first search query, to generate a forecast indicating a size of the first subset and/or a likely cost for use, by the user, of the first subset; and
causing the output device to display the forecast for the user.

27. The non-transitory computer-readable medium of claim 18, further comprising instructions stored thereon, that when performed by a processor cause the second hardware processing device to perform the steps of:
comparing the first dataset with a second dataset provided by the user; and
joining the first dataset with the second dataset to generate a second subset of the first dataset that:
(1) does not overlap with the second dataset;
(2) overlaps with the second dataset; and/or
(3) intersects with the second dataset.

28. A system for managing access to data over a network, the system comprising:
a first hardware processing device configured to automatically read a first dataset to infer one or more data types of data within the first dataset;
a communication device, communicatively coupled to the first hardware processing device, configured to make a data product available over the network, the data product comprising at least part of the first dataset;
an input device, communicatively coupled to the communication device, configured to receive, from a user, a first search query specifying one or more attributes of data desired by the user, wherein the attributes are based on the data types;
a second hardware processing device connected to the network and configured to, responsive to the first search query, identify a first subset of the first dataset, wherein the first subset possesses the attributes; and
an output device, communicatively coupled to the second hardware processing device, configured to display results of the first search query for the user.

29. The system of claim 28, wherein the first hardware processing device is further configured to infer the one or more data types by:
identifying delimiters within the first dataset to divide the first dataset into a plurality of fields; and
examining contents of one or more of the fields to determine that the contents have a common data type.

30. The system of claim 28, wherein the communication device is further configured to make the data product available over the network by:
including a second dataset in the data product, the second dataset being from a different provider from the first dataset; and
normalizing a first field of the first dataset with a second field of the second dataset to facilitate comparison, by the user, of the first field with the second field.

31. The system of claim 28, the communication device is further configured to make the data product available over the network by:
excluding one or more fields of the first dataset from the data product; and/or
establishing a price for use, by the user, of the data product.

32. The system of claim 28, wherein:
the one or more attributes comprise a field of interest to the user; and
the input device is further configured to receive the first search query by receiving an indication, from the user, that the field of interest is to be filterable.

33. The system of claim 28, wherein the input device is further configured to receive the first search query by receiving, from the user, a budget indicative of how much the user is willing to pay for use of the data product.

34. The system of claim 28, wherein:
the input device is further configured to receive, after display of the results of the first search query, a second search query;
the second hardware processing device is further configured, responsive to the second search query, to identify a second subset of the first subset of the first dataset; and
the output device is further configured to display results of the second search query for the user.

35. The system of claim 28, wherein the input device is further configured, after displaying the results of the first search query, to receive user input indicating a desire to purchase use of the first subset.

36. The system of claim 28, wherein:
the second hardware processing device is further configured, responsive to the first search query, to generate a forecast indicating a size of the first subset and/or a likely cost for use, by the user, of the first subset; and
the output device is further configured to display the forecast for the user.

37. The system of claim 28, wherein the second hardware processing device is further configured to:
compare the first dataset with a second dataset provided by the user; and
join the first dataset with the second dataset to generate a second subset of the first dataset that:
(1) does not overlap with the second dataset;
(2) overlaps with the second dataset; and/or
(3) intersects with the second dataset.
